(19) United States
(12) Patent Application Publication
(10) Pub. No.: US 2019/0372769 A1
(43) Pub. Date: Dec. 5, 2019

(54) BLOCKCHAIN-UNIVERSAL DOCUMENT IDENTIFICATION

(71) Applicant: Integra, Inc., Denver, CO (US)

(72) Inventors: David A. Fisher, Centennial, CO (US); David O. Berger, Las Vegas, NV (US)

(21) Appl. No.: 16/430,381

(22) Filed: Jun. 3, 2019

Related U.S. Application Data
(60) Provisional application No. 62/679,260, filed on Jun. 1, 2018.

(51) Int. Cl. H04L 9/32; G06K 19/06; G06K 7/14; G06K 7/10

(52) U.S. Cl. CPC H04L 9/3226; H04L 9/3247; H04L 2209/38; G06K 7/1417; G06K 7/10722; G06K 19/06037

(57) ABSTRACT

A visual code may be used to embed a universal identifier directly into document content. The universal identifier may include a reference to a respective location within a distributed ledger and can be used to retrieve information related to the document including version information, author information, audit information, and signature information.

### CROSS-REFERENCE TO RELATED APPLICATION

This application is related to and claims priority under 35 U.S.C. § 119(e) from U.S. Patent Application No. 62/679,260, filed Jun. 4, 2018 entitled “Blockchain-Universal Document Identification,” the entire contents of which is incorporated herein by reference for all purposes.

### TECHNICAL FIELD

The present invention relates to document management over a distributed ledger. In particular, the present invention relates to universal document identification and document audit trail generation and maintenance linked to a visual code.

### BACKGROUND

Verifying the authenticity of a physical document can often be a challenging and tedious process. For example, contract documents may lack any identifier for digital verification or, if they do include such an identifier, often require a person inspecting the document to manually enter the identifier and perform an inspection in an altogether separate process and location. Further, digital identifiers such as serial numbers and the like cannot include expanded data elements. As a result, it is often difficult or impossible when using a physical document, for example, to verify the integrity of the document and its contents, retrieve and review an access history of the document, or verify the integrity of the identifier.

### SUMMARY

In one embodiment, a method for managing documents on a distributed ledger includes generating a document including content and metadata, associating the document with a unique identifier on a distributed ledger, generating a visual code based on the unique identifier, and embedding the visual code into one of the content or the metadata of the document.

In one embodiment of the method, the method further includes receiving the visual code, extracting the unique identifier from the visual code, and verifying existence of the unique identifier on the distributed ledger.

In one embodiment of the method, the method further includes receiving data from the distributed ledger in response to verifying the existence of the unique identifier, the data including executable instructions for operations associated with the document, and executing the executable instructions.

In one embodiment of the method, the executable instructions include signature rules.

In one embodiment of the method, the unique identifier is associated with respective data on the distributed ledger.

In one embodiment of the method, the distributed ledger includes a blockchain data structure.

In one embodiment of the method, the visual code is received by a camera on a smartphone.

In one embodiment, a system for managing documents on a distributed ledger includes one or more processors, and a memory storing instructions executable by the one or more processors to generate a document including content and metadata, associate the document with a unique identifier on a distributed ledger, generate a visual code based on the unique identifier, and embed the visual code into one of the content or the metadata of the document.

In one embodiment of the system, the memory stores further instructions to receive the visual code, extract the unique identifier from the visual code, and verify existence of the unique identifier on the distributed ledger.

In one embodiment of the system, the memory stores further instructions to receive data from the distributed ledger in response to verifying the existence of the unique identifier, the data including executable instructions for operations associated with the document, and execute the executable instructions.

In one embodiment of the system, the executable instructions include signature rules.

In one embodiment of the system, the unique identifier is associated with respective data on the distributed ledger.

In one embodiment of the system, the distributed ledger includes a blockchain data structure.

In one embodiment of the system, the system includes a camera on a smartphone and the visual code is received by the camera on the smartphone.

In one embodiment, a non-transitory computer readable medium storing instructions that, when executed by one or more processors, causes the one or more processors to generate a document including content and metadata, associate the document with a unique identifier on a distributed ledger, generate a visual code based on the unique identifier, and embed the visual code into one of the content or the metadata of the document.

In one embodiment of the non-transitory computer readable medium, the instructions further cause the one or more processors to receive the visual code, extract the unique identifier from the visual code, and verify existence of the unique identifier on the distributed ledger.

In one embodiment of the non-transitory computer readable medium, the instructions further cause the one or more processors to receive data from the distributed ledger in response to verifying the existence of the unique identifier, the data including executable instructions for operations associated with the document, and execute the executable instructions.

In one embodiment of the non-transitory computer readable medium, the executable instructions include signature rules.

In one embodiment of the non-transitory computer readable medium, the unique identifier is associated with respective data on the distributed ledger.

In one embodiment of the non-transitory computer readable medium, the distributed ledger includes a blockchain data structure.

### BRIEF DESCRIPTION OF THE DRAWINGS

FIG. 1 is a diagram illustrating an example of an operating environment in which embodiments of the present disclosure may be implemented;

FIG. 2 is a diagram illustrating a data structure for storing paired document identifiers and associated data, according to one embodiment of the present disclosure;

FIG. 3 is a diagram illustrating a document identification system, according to one embodiment of the present disclosure;

FIG. 4 is a flowchart illustrating a method for retrieving associated data for an embedded document identification, according to one embodiment of the present disclosure;

FIG. 5 is a flowchart illustrating a method for managing versions of a document associated with an identifier stored on a distributed ledger, according to one embodiment of the present disclosure;

FIG. 6 is a flowchart illustrating a method for digitally signing a document associated with a universal document identification, according to one embodiment of the present disclosure; and

FIG. 7 is a diagram illustrating an example of a computing system which may be used in implementing embodiments of the present disclosure.

### DETAILED DESCRIPTION

A distributed ledger, such as a blockchain network or the like, can be used to store a universal identifier (UID) associated with a particular document. Further, various additional features may be associated directly or indirectly with the UID such as, for example, an audit trail, signing rules, visual data encodings (e.g., bar codes, QR codes, etc) and the like. The document may be a digital file such as, for example and without imputing limitation, an Adobe® Acrobat® file (.PDF), Microsoft® Word® file (.DOC, .DOCX), email, photograph, spreadsheet, invoice, structured data, or unstructured data, and may also include physical document representations (e.g., paper documents, etc.).

In particular, a UID can be associated with a particular document by embedding the UID into the document in digital form. The UID can be embedded into the document via associated metadata. For example, a metadata field may store the UID. Further, a QR code can be generated based on some or all of the metadata and so may provide a link to a location associated with the document and within a distributed ledger (e.g., a document address on a blockchain, etc.).

In some examples, the UID may be associated with a particular version of the document and, as a result, different document versions may be associated with different UIDs. As a result, each document version may include a different respective QR code. Further, each UID can be associated with additional data, stored within the metadata of the document itself and/or in a content store associated with the UID on the distributed ledger, that may include, for example and without imputing limitation, access control lists, audit information, executable instructions, and various other features as disclosed by U.S. patent application Ser. No. 16/417,698, entitled “BLOCKCHAIN-ANCHORED SMART DOCUMENTS” filed May 21, 2019, incorporated in its entirety herein by reference.

As a result, a visual code (e.g., QR code, etc.) of the document can be used to identify an owner of the document (e.g., by name, public key, signature, etc.), a place (e.g., location or entity) of origin for the document, access and/or modification histories and information (e.g., identification of modifiers and/or accessors, nature of modifications, sequence of modifications and/or views, etc.), creation time of the document, digital signatories to the document, document version information, and the like.

For example, a QR code can be generated for the document based on the UID and/or associated data for the UID (e.g., including the above items directly within the document metadata or stored as associated data on the distributed ledger). The generated QR code can be inserted directly into the document in a visually recognizable form and a QR code reader may be used to read the QR code and extract the data used to generate the QR code, including the document UID. Once retrieved, the extracted data can be used to access and/or perform particular operations associated with the document through the UID such as public key signing and the like. In effect, the document, in whole or in part, can be accessed through the QR code at various times and places while ensuring integrity of the document and its contents, tracking all accesses and modifications to the document itself, retrieving some or all of the foregoing information from the metadata of the document, and verifying integrity of the foregoing information via interfacing (e.g., using the UID) with distributed ledger technologies (e.g., blockchain, etc.).

In some examples, each version of the document may include and/or be associated with a unique UID and QR code. As a result, one QR code refers to the most recent version of the document and each other QR code refers to earlier version of the document to form an audit trail via associated data for each respective QR code via respective UIDs.

A visual code (e.g., QR code, etc.) can be included on printed versions of the document and can, for example and without imputing limitation, be scanned by a QR reading software application to reveal an underlying audit trail for the document. In some examples, the document can be digitally displayed along with the QR code on a screen or monitor. In this way, the screen display may function in much the same way as the printed document (e.g., a QR software application may read the QR code from the screen or monitor directly or through software interfaces, etc.).

In some examples, the QR code may directly unveil information stored in relevant document metadata. In other examples, a QR code may point to a location or a “code container” where such metadata can be accessed. Further, access to the metadata may be controlled by a cryptographic key and/or via privacy-enhancing technologies (e.g., asynchronous encryption, identity ledger interfaces, etc.).

For example, in the case of a smart contract with multiple parties, the smart contract can be associated with a UID (e.g., as embedded in a QR code) which may include via associated data one or more foreign keys for access to information in the document or associated documents. In effect, relevant documents across corporate or system boundaries can still be shared, through the UID and via respective QR codes, between or among the relevant parties to the contract. Parties can provide identification via, for example and without imputing limitation, a public key and may thus be able to access and/or read metadata associated with respective documents. Additionally, the parties may then digitally sign the document by storing the signature (e.g., a public key) on a distributed ledger in association with the document.

Distributed ledger technology, such as blockchain networks, can be used to convey trust and/or instant repudiation or acceptance to party requesting access to a document and/or authorization (e.g., to access the document, perform operations associated with the document as executable computer code or as described within the document as directives, etc.). In some examples, parties not authorized to access any or most metadata may still verify integrity of a document identified via a respective UID without being granted access to associated metadata. As a result, document verification can be made through a visual code without disclosure of the document contents.

Additional benefits of using a visual code (e.g., QR code, etc.), may include, for example and without imputing limitation, other indicators, containers, and/or pointers to other UIDs and/or metadata, and a visual indication that the document includes a correct UID. In some examples, a user may interact with the document via a respective QR code using a software application on, for example and without imputing limitation, a camera-enabled device such as a smartphone even if the document is in non-digital form, such as a printed or on-screen copy. For example, a user may point a smartphone camera at the document and obtain information such as, for example and without imputing limitation, an indication of whether the document being viewed is the latest copy and/or version of the document, a list of changes made to the document, and/or notes and comments associated with the document (e.g., stored in the document metadata, embedded directly into the QR code, or retrieved from a data store associated with the document UID). In one example, the information can be presented on screen so that augmented reality technology, virtual reality technology, and the like may be used to display the respective document information.

In some examples, the software application may include support for digital signatures. For example, public private key asymmetric cryptography (or other key-producing technology meeting the parties' security needs) may be used to generate a private key and securely store it locally (to the software application) and/or synchronized to a secure off-device system (e.g., an enterprise key vault, identity ledger, etc.). The public key may then be registered, and made available, on a distributed ledger.

In particular, when a user points a camera connected to the software application at a printed document or on-screen display of the document, a UID can be extracted from the visual information and used to validate the document on a respective distributed ledger. When the user digitally signs the document referred to by the UID, the signature may be submitted to the distributed ledger for permanent recordation. The signing may generate an identifier (which may also have a visual code (e.g., QR code, etc.) referring to the UID) which can then be associated with the document UID. Further, the identifier generated by the signature can be added to metadata associated directly with the document (e.g., as part of the document file and/or via a data store associated with the UID). As a result, the UID may point to and verify that the respective document is the only and/or latest document version.

In some examples, because a record of interactions, modifications, views, signatures, and edits to a respective digital document source being maintained in a centralized store, modifications to the respective document may be linked to respective original sources of each element of the record. As a result, a chain of integrity for the respective document may be maintained in an auditable form. For example, an author of a contract creates a document in Microsoft® Word® with a plugin installed that automatically registers the document on the distributed ledger which returns a respective document identifier associated with the registered document. The plugin may then embed the returned document identifier into the document and associate the returned document identifier with a UID. Further, the plugin may generate a QR code based on the UID and returned document identifier and automatically insert the QR code into the content of the document. In the case of multiple stored forms of the same document (e.g., .DOC, .DOCX, .PDF, etc.), each such document format may be associated with a different respective UID.

When the document is edited by a user (another or the same user who created the original document), the resulting new document (e.g., the document in its new, modified state) can be hashed and the hash recorded in a distributed ledger with a link to the UID and the document identifier associated with the prior state. In some examples, a QR code or other visual code may contain the new document UID as well as the prior state UID and document identification. In some examples, the QR code for the prior state may be included within the document (e.g., at a specified location distinguishing it from the current state QR code). Nevertheless, a link to a distributed ledger storing UIDs and associated data may be generated and inserted into the new document via respective metadata and/or the respective QR code.

In effect, regardless of document file format, a QR code reader can be used to retrieve and view information related to the document through the respective UID. In some examples, a specialized software application (e.g., installed to a smartphone, etc.) associated with a user who has a registered (e.g., on a specified identity ledger, centralized database, etc.) public key, can generate a signature prompt in response to a linked camera being pointed at a QR code for a document (e.g., printed directly onto the document, etc.). The user may then use the public key to digitally sign the document associated with the given UID. The record of the signature may be recorded in a distributed ledger storing UIDs and associated data. As a result, a subsequent user retrieving the UID via the QR code can see the document had been digitally signed by the preceding user (e.g., via the public key entry, etc.).

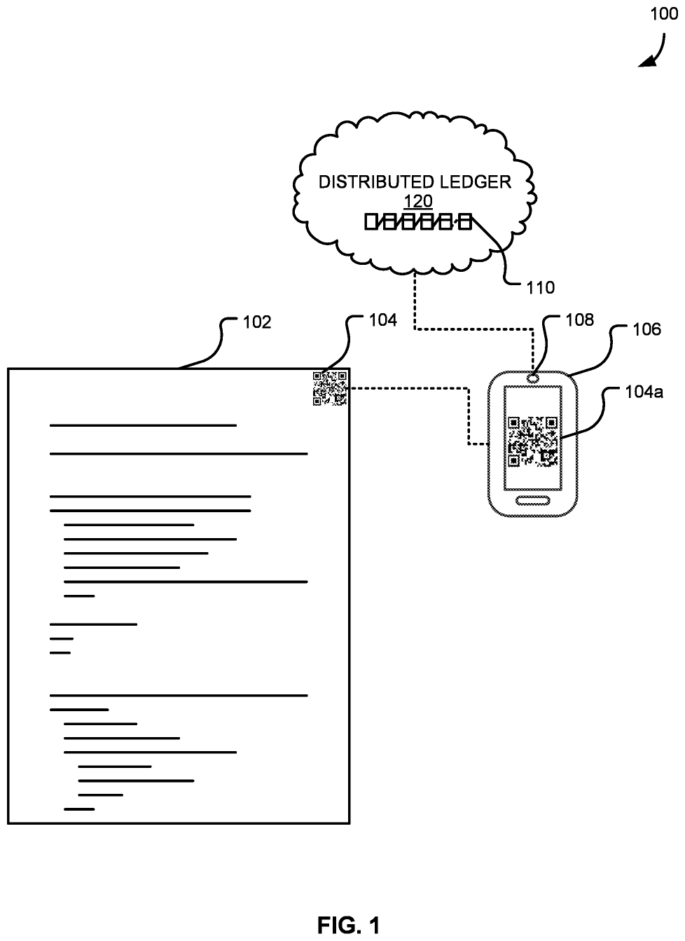

FIG. 1 depicts an operating environment 100 in which a computer device 106 may access detailed information related to a document 102. As depicted, computer device 106 is a smartphone, however it will be understood by a person having ordinary skill in the art with the benefit of this disclosure that computer device 106 may include, for example and without limitation, a desktop computer, a laptop computer, mobile computer, tablet computer, or other computer device.

In particular, computer device 106 includes a camera 108 for receiving visual data. Here, computer device 106 retrieves a QR code 104, via camera 108, embedded onto a document 102. Document 102 may be a physical (e.g., paper) document such as a contract, draft copy, or other document as described above. QR code 104 is generated based on metadata associated with document 102 (e.g., in a respective digital format, etc.) such as a UID and/or document identifier as described above.

Nevertheless, computer device 104 extracts UID and/or document identifier information from retrieved QR code 104a. The extracted information is then used to interface with a distributed ledger 120 which contains a record of the UID. Here, distributed ledger 120 includes a blockchain 110, though other data structures may be used. In some examples, computer device 106 may include digital signing software which may retrieve signature rules and the like stored, for example, on blockchain 110 in data associated with the UID. As a result, document 102 may be verified as an authentic document by the UID included within QR code 104 and/or may be digitally interacted with through interfacing applications and the like.

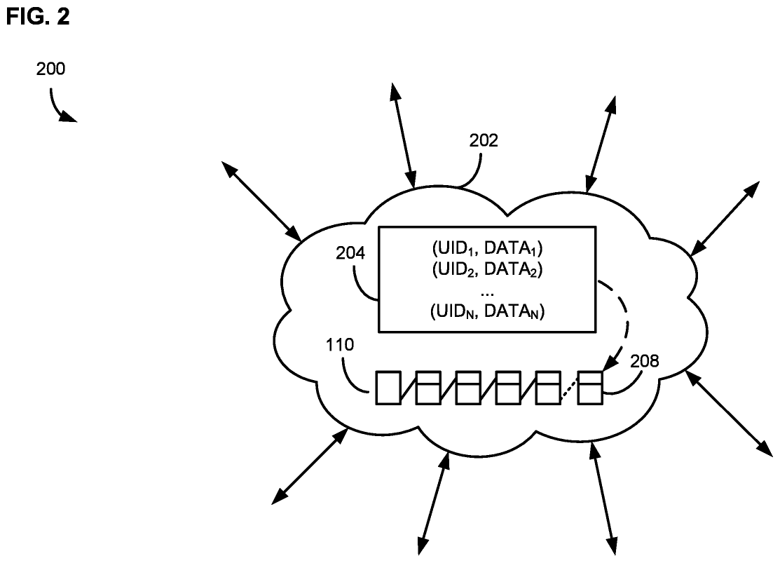

FIG. 2 depicts a distributed ledger 200 for storing UIDs (e.g., as discussed above) and interacting with a document via, for example, QR code 104. In particular distributed ledger 200 resides on a network 202 and may include nodes at one or more locations throughout network 202. In some examples, constituent nodes may each store different respective portions of blockchain 110. In other examples, nodes may store overlapping or redundant portions of blockchain 110.

Further, blockchain 110 includes sequential blocks 208 which may be interlinked in sequence with hashed linkages providing immutability and ordering to the overall data structure. Nevertheless, each block 208 includes a collection 204 of pairings (e.g., tuples, etc.) of respective UIDs and Data. For example, as depicted, a UID₁ is paired with DATA₁. As described above, UID₁ is associated with a particular document version and, in some examples, may be embedded into QR code 104 as a UID value. In some examples, DATA₁ stores additional data for interacting with the respective particular document such as access control lists, audit trails, version information (e.g., other UIDs for earlier versions of the respective particular document), etc.

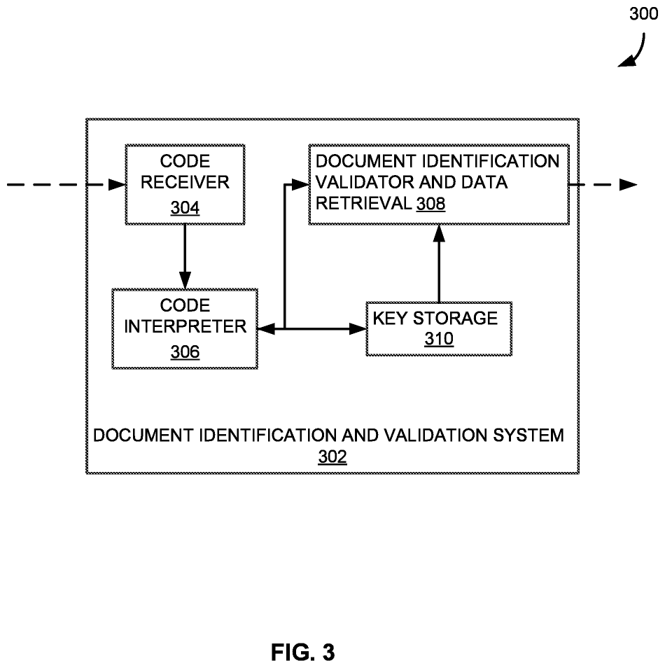

FIG. 3 depicts a system 300 for retrieving a UID associated with a document and/or interacting with the document. System 300 may be a software implemented system stored on, for example and without imputing limitation, a computing device such as a smartphone, desktop computer, laptop or portable computer, tablet computer, or other computing device.

In particular, a document identification and validation system 302 receives code information via a code receiver process 304. In some examples, a hardware camera may provide visual data directly to code receiver process 304 for downstream processing. In some examples, code receiver process 304 may receive visual information through an import functionality (e.g., receive file formats such as .JPEG, .PNG, .BMP, etc.) or through a manual code entry such as via entry of a serial number, etc.

Code receiver process 304 provides the received code information to code interpreter process 306. Code interpreter process 306 may process received code information to extract various values from the code information. Here, code interpret process 306 extracts a document identification and/or UID from the code information. The document identification and/or UID are provided to a document identification validator and data retrieval process 308 and may be used to interface with distributed ledger 120 (described above). In some examples, code interpreter process 306 may also execute instructions included within the code information or retrieved by document identification validator and data retrieval process 308 from, for example, a paired DATA_{N} portion of a record for a UID_{N}. In some examples, code interpreter process 306 may retrieve information from a key storage 310, such as to provide a signature in response to a prompt from code interpreter process 306 as it executes instructions or the like.

Document identification validator and data retrieval process 308 includes an interface with distributed ledger 120 and may perform a lookup action for the UID and/or document identification on distributed ledger 120. In response, distributed ledger 120 returns verification of the document (e.g., indication that the document has been registered under the respective UID and/or document identification) and, in some examples, may return additional information such as metadata, executable code, and the like store in, for example, a DATA store paired to the UID and/or document identification. In some examples, the metadata and/or executable code may be provided to code interpreter process 306 to perform, for example, access control operations, signature requests, and/or other operations. In some examples, document identification validator and data retrieval process 308 can provide some or all retrieved information downstream to additional processes and/or services.

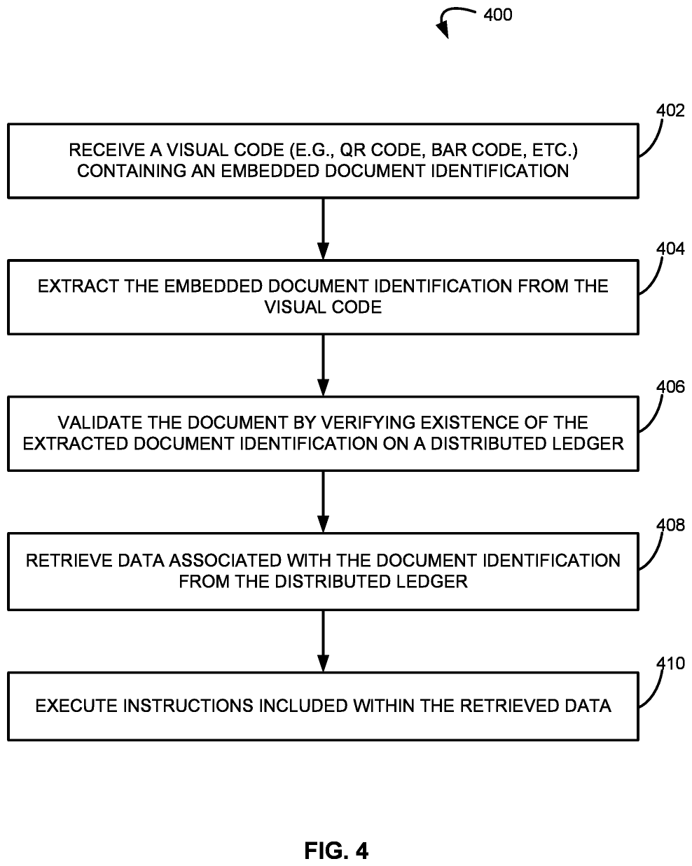

FIG. 4 depicts a UID and associated data access method 400 which may be performed by, for example and without imputing limitation, system 300 or the like. UID and associated data access method 400 may use a visual code to retrieve and execute particular instructions associated with a UID associated with a document (e.g., including the visual code within its content, etc.).

At step 402, a visual code, such as a QR code or bar code, is received which contains an embedded document identification. The visual code may be received through a camera or similar component. In some examples, the visual code may be received via an import function or the like. In some examples, the visual code may be manually entered through an interface.

At step 404, the embedded document identification is extracted from the received code. For example, code interpreter process 306, or a substantially similar process, may extract the document identification from the received code and provide it downstream for further use and processing.

At step 406, the document is validated by verifying that the extracted document identification exists on an appropriate distributed ledger. In some examples, document identification validator and data retrieval process 308, or a substantially similar process, may interface with the appropriate distributed ledger to query the ledger for the extracted document identification.

At step 408, data associated with the document identification is retrieved from the distributed ledger. In some examples, the distributed ledger may return associated data from the distributed ledger in response to a query containing the document identification. In some examples, a key or other identifier may be required for the associated data to be returned, only certain portions of the associated data may be returned, or the associated data may be returned in an encrypted form or the like.

At step 410, instructions included within the retrieved data are executed. The instructions may be executed by, for example, code interpreter process 306, or a substantially similar process. In some examples, the instructions may include prompting an accessing user for a signature or the like (e.g., by providing a public key, etc.)

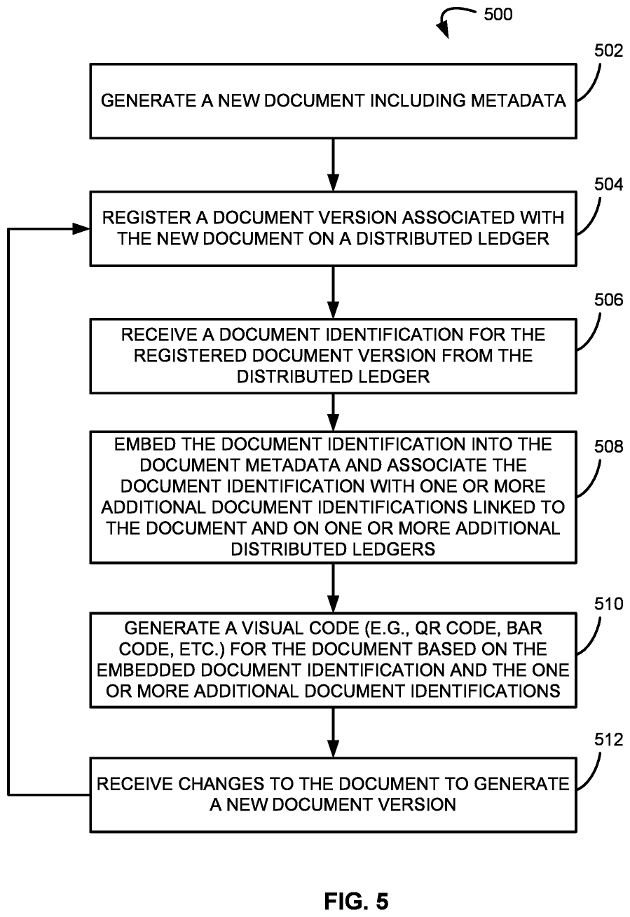

FIG. 5 depicts a UID management method 500 for associating document versions with multiple UIDs on a distributed ledger. At step 502, a new document including metadata is generated.

At step 504, a document version associated with the new document is registered on a distributed ledger. For example, an interface for the distributed ledger may be used to register a new entry on the distributed ledger. In some examples, the some or all of the new document and/or the included metadata may be provided to, and stored on, the distributed ledger in association with a respective registration.

At step 506, a document identification for the registered document version is received from the distributed ledger. The document identification may be a UID and can include a hash address or the like indicating a location within the distributed ledger.

At step 508, the received document identification is embedded into the document metadata and associated with additional document identifications each linked to the new document and stored on additional distributed ledgers. For example, multiple distributed ledgers or systems may be used to keep track and maintain redundancy of document identification or the like. In some examples, the additional ledgers may be identity ledgers or the like.

At step 510, a visual code is generated for the document based on the embedded document identification and the one or more additional document identifications. For example, the visual code may be a QR code, bar code, or the like.

At step 512, changes are received to the document and a new document version is generated. In particular, step 512 may return to step 504 and so a new document version may be registered on the distributed ledger. Accordingly, a new document version identification is received, associated with any other additional document identifications, and a corresponding visual code is generated and embedded into the new document version metadata. In some examples, the new version may include a reference to the preceding version (e.g., by including the preceding document version identification) and, as a result, a chain of versions may be maintained on the distributed ledger and traversed as needed.

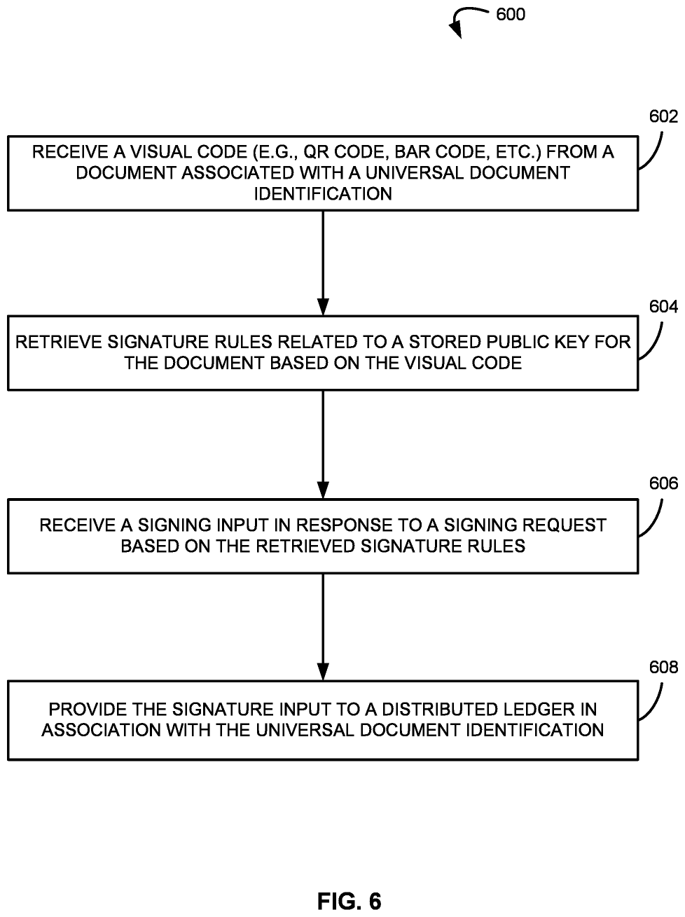

FIG. 6 depicts a document signing method 600 for documents associated with a UID. At step 602, a visual code, such as a QR code or bar code, is received from a document associated with a universal document identification (e.g., UID). In some examples, the visual code is received via camera on a computing device, such as smartphone computer device 106.

At step 604, signature rules related to a stored public key for the document are retrieved based on the visual code. For example, the receiving device may include a stored key value and/or a distributed ledger storing the UID for verification purposes may return the signature rules in a validation query.

At step 606, a signing input is received in response to a signing request based on the retrieved signature rules. In some examples, the signature rules may include various conditions tailored to signing identity, timing, or other external factors.

At step 608, the received signature input is provided to a distributed ledger in association with the UID. For example, the UID may be associated with one or more public keys denoting various signatories to the respective associated document. As a result, the document may be signed via interaction with an associated visual identifier (e.g., QR code).

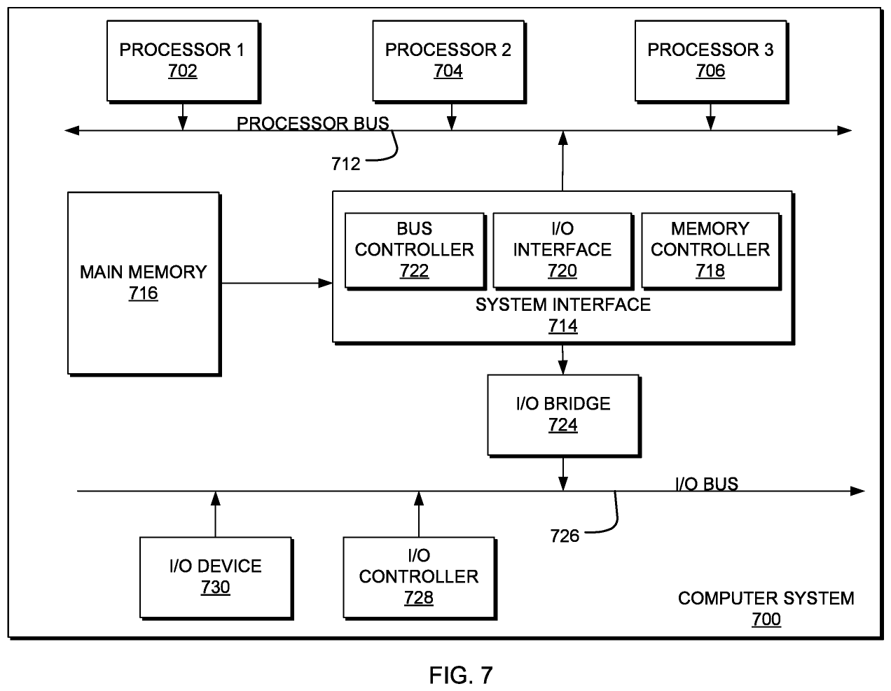

FIG. 7 is a block diagram illustrating an example of a computing device or computer system 700 which may be used in implementing the embodiments of the systems disclosed above. For example, the computing system 700 of FIG. 7 may be smartphone 106 from FIG. 1 and/or a node within blockchain distributed ledger 120 discussed above. The computer system (system) includes one or more processors 702-706. Processors 702-706 may include one or more internal levels of cache (not shown) and a bus controller or bus interface unit to direct interaction with the processor bus 712. Processor bus 712, also known as the host bus or the front side bus, may be used to couple the processors 702-706 with the system interface 714. System interface 714 may be connected to the processor bus 712 to interface other components of the system 700 with the processor bus 712. For example, system interface 714 may include a memory controller 718 for interfacing a main memory 716 with the processor bus 712. The main memory 616 typically includes one or more memory cards and a control circuit (not shown). System interface 714 may also include an input/output (I/O) interface 720 to interface one or more I/O bridges or I/O devices with the processor bus 712. One or more I/O controllers and/or I/O devices may be connected with the I/O bus 726, such as I/O controller 728 and I/O device 730, as illustrated. The system interface 714 may further include a bus controller 722 to interact with processor bus 712 and/or I/O bus 726.

I/O device 730 may also include an input device (not shown), such as an alphanumeric input device, including alphanumeric and other keys for communicating information and/or command selections to the processors 702-706. Another type of user input device includes cursor control, such as a mouse, a trackball, or cursor direction keys for communicating direction information and command selections to the processors 702-706 and for controlling cursor movement on the display device.

System 700 may include a dynamic storage device, referred to as main memory 716, or a random access memory (RAM) or other computer-readable devices coupled to the processor bus 712 for storing information and instructions to be executed by the processors 702-706. Main memory 716 also may be used for storing temporary variables or other intermediate information during execution of instructions by the processors 702-706. System 700 may include a read only memory (ROM) and/or other static storage device coupled to the processor bus 712 for storing static information and instructions for the processors 702-706. The system set forth in FIG. 7 is but one possible example of a computer system that may employ or be configured in accordance with aspects of the present disclosure.

According to one embodiment, the above techniques may be performed by computer system 700 in response to processor 704 executing one or more sequences of one or more instructions contained in main memory 716. These instructions may be read into main memory 716 from another machine-readable medium, such as a storage device. Execution of the sequences of instructions contained in main memory 716 may cause processors 702-706 to perform the process steps described herein. In alternative embodiments, circuitry may be used in place of or in combination with the software instructions. Thus, embodiments of the present disclosure may include both hardware and software components.

A machine readable medium includes any mechanism for storing or transmitting information in a form (e.g., software, processing application) readable by a machine (e.g., a computer). Such media may take the form of, but is not limited to, non-volatile media and volatile media. Non-volatile media includes optical or magnetic disks. Volatile media includes dynamic memory, such as main memory 716. Common forms of machine-readable medium may include, but is not limited to, magnetic storage medium; optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

The description above includes example systems, methods, techniques, instruction sequences, and/or computer program products that embody techniques of the present disclosure. However, it is understood that the described disclosure may be practiced without these specific details. In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

It is believed that the present disclosure and many of its attendant advantages should be understood by the foregoing description, and it should be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it should be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A method for managing documents on a distributed ledger, the method comprising:
generating a document comprising content and metadata;
associating the document with a unique identifier on a distributed ledger;
generating a visual code based on the unique identifier; and
embedding the visual code into one of the content or the metadata of the document.

2. The method of claim 1, further comprising:
receiving the visual code;
extracting the unique identifier from the visual code; and
verifying existence of the unique identifier on the distributed ledger.

3. The method of claim 2, further comprising:
receiving data from the distributed ledger in response to verifying the existence of the unique identifier, the data comprising executable instructions for operations associated with the document; and
executing the executable instructions.

4. The method of claim 3, wherein the executable instructions comprise signature rules.

5. The method of claim 1, wherein the unique identifier is associated with respective data on the distributed ledger.

6. The method of claim 1, wherein the distributed ledger comprises a blockchain data structure.

7. The method of claim 2, wherein the visual code is received by a camera on a smartphone.

8. A system for managing documents on a distributed ledger, the system comprising:
one or more processors; and
a memory comprising instructions executable by the one or more processors to:
generate a document comprising content and metadata;
associate the document with a unique identifier on a distributed ledger;
generate a visual code based on the unique identifier; and
embed the visual code into one of the content or the metadata of the document.

9. The system of claim 8, wherein the memory further comprises instructions to:
receive the visual code;
extract the unique identifier from the visual code; and
verify existence of the unique identifier on the distributed ledger.

10. The system of claim 9, wherein the memory further comprises instructions to:
receive data from the distributed ledger in response to verifying the existence of the unique identifier, the data comprising executable instructions for operations associated with the document; and
execute the executable instructions.

11. The system of claim 10, wherein the executable instructions comprise signature rules.

12. The system of claim 8, wherein the unique identifier is associated with respective data on the distributed ledger.

13. The system of claim 8, wherein the distributed ledger comprises a blockchain data structure.

14. The system of claim 9, further comprising a camera on a smartphone and wherein the visual code is received by the camera on the smartphone.

15. A non-transitory computer readable medium comprising instructions that, when executed by one or more processors, causes the one or more processors to:
generate a document comprising content and metadata;
associate the document with a unique identifier on a distributed ledger;
generate a visual code based on the unique identifier; and
embed the visual code into one of the content or the metadata of the document.

16. The non-transitory computer readable medium of claim 15, further comprising instructions to:
receive the visual code;
extract the unique identifier from the visual code; and
verify existence of the unique identifier on the distributed ledger.

17. The non-transitory computer readable medium of claim 16, further comprising instructions to:
receive data from the distributed ledger in response to verifying the existence of the unique identifier, the data comprising executable instructions for operations associated with the document; and
execute the executable instructions.

18. The non-transitory computer readable medium of claim 17, wherein the executable instructions comprise signature rules.

19. The non-transitory computer readable medium of claim 15, wherein the unique identifier is associated with respective data on the distributed ledger.

20. The non-transitory computer readable medium of claim 15, wherein the distributed ledger comprises a blockchain data structure.
